(19) United States
(12) Patent Application Publication
(10) Pub. No.: US 2007/0252362 A1
(43) Pub. Date: Nov. 1, 2007

(54) Hybrid skateboard deck

(76) Inventor: Scott Burwell, San Clemente, CA (US)

Correspondence Address: CROCKETT & CROCKETT, 24012 CALLE DE LA PLATA, SUITE 400, LAGUNA HILLS, CA, 92653, US

(21) Appl. No.: 11/796,319

(22) Filed: Apr. 26, 2007

Related U.S. Application Data
(60) Provisional application No. 60/795,949, filed on Apr. 28, 2006.

(51) Int. Cl. B62M 1/00

(52) U.S. Cl. 280/610; 428/537.1

(57) ABSTRACT

A hybrid skateboard deck combines at least one layer of bamboo with one or more layers of any suitable wood to form a multi-ply deck. A hybrid skateboard deck combines at least one layer of bamboo sandwiched between at least two layers of conventional hardwood such as maple. The addition of a bamboo layer in the core of the laminated deck provides superior strength relative to conventional plywood decks. The bamboo core laminate also provides superior feedback to a rider as well as uniform stiffness.

### RELATED APPLICATIONS

This application claims priority from copending U.S. Provisional patent application 60/795,949 filed Apr. 28, 2006.

### FIELD OF THE INVENTIONS

The inventions described below relate to the field of sporting goods and more specifically to skateboard deck composition.

### BACKGROUND OF THE INVENTIONS

Conventional skateboard deck composition began with single layer wood panels and evolved to high technology composites as well as metal composite combinations. The currently preferred decks are formed of layers of maple and or birch.

What is needed is a composite deck that is slightly stiffer than conventional decks and retains the ‘feel’ of wood decks with high durability.

### SUMMARY

Bamboo is a natural material that has many suitable properties, however it is not been used in plywood because bamboo may not be peeled to form thin layers as is done with wood. Bamboo is a grass and must be cut into thin strips and the strips arranged parallel to each other and glued together to form a thin layer of parallel strips. Historically, this process has not yielded suitable layers for laminating. If these layers are used on the top or bottom of a laminated skateboard deck they are highly susceptible to delamination and do not impart uniform stiffness or flex to a skateboard deck.

A hybrid skateboard deck combines at least one layer of bamboo with one or more layers of any suitable wood to form a multi-ply deck. Any suitable selection and arrangement of wood layers may be combined with the one or more layers of bamboo to form a hybrid skateboard deck.

A hybrid deck may have from two to ten layers or ply's that may be formed of any suitable wood or combinations of wood. The layers may be joined using any suitable technique and any suitable adhesive, resin, glue or other material.

A hybrid skateboard deck combines at least one layer of bamboo sandwiched between at least two layers of conventional hardwood such as maple. The addition of a bamboo layer in the core of the laminated deck provides superior strength relative to conventional plywood decks. The bamboo core laminate also provides superior feedback to a rider as well as uniform stiffness.

A hybrid skateboard deck combines outer layers of conventional wood with a multi-layer hybrid core. The outer layers, top and bottom layers, may be formed of any suitable wood such as maple. The hybrid core may be formed of at least one layer of bamboo.

### BRIEF DESCRIPTION OF THE DRAWINGS

FIG. 1 is a perspective view of a seven-layer hybrid deck according to the present disclosure.

FIG. 2 is a top view of the deck of FIG. 1.

FIG. 3 is an end view of the deck of FIG. 1.

FIG. 4 is an exploded view of a six-layer deck according to the present disclosure.

FIG. 5 is a perspective view of an alternate bamboo layer according to the present disclosure.

FIG. 6 is an exploded view of an alternate seven-layer deck according to the present disclosure.

FIG. 7 is an exploded view of another alternate seven-layer deck according to the present disclosure.

### DETAILED DESCRIPTION OF THE INVENTIONS

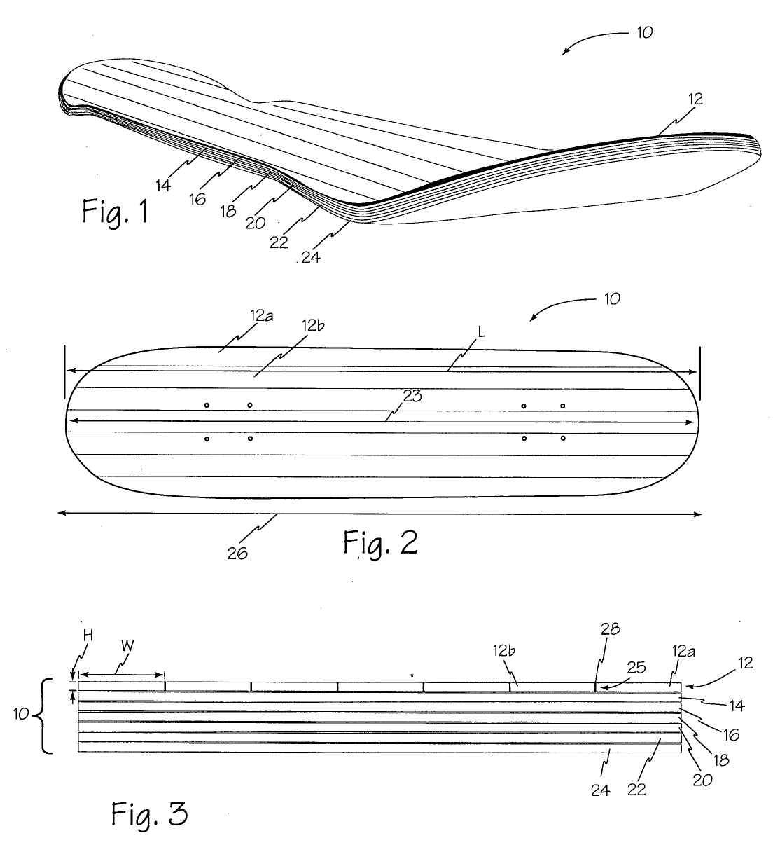

Hybrid deck 10 of FIG. 1 includes at least one bamboo layer such as bamboo layer 12 combined with one or more other layers of any suitable wood such as layers 14, 16, 18, 20, 22, and 24. Bamboo layer 12 may be any layer of the deck. The additional layers, wood layers 14, 16, 18, 20, 22, and 24, may be any other suitable wood or combinations of wood such as but not limited to maple, birch, beech, cherry, elm, gum, hickory and or mesquite. For example a seven-layer deck may include a bamboo layer, two maple layers, another bamboo layer, two birch layers and a mesquite layer. The process of laminating the layers to form a skateboard deck may employ any suitable technique, and any suitable glue, resin or other adhesive and or filler to form a suitable multilayer deck.

Referring now to FIG. 2 and FIG. 3, bamboo layer 12 may be formed of two or more strips of bamboo having at least length L, a width W from edge to edge, and a height or thickness H. Joining multiple parallel strips together forms a strip axis 23. The strips are joined along generally parallel edges such as edges 25 to form a thin layer with the bamboo grain parallel to strip axis 23, and in this example also parallel to long axis 26 of deck 10. Joints between bamboo strips such as joint 28 may be formed using any suitable technique.

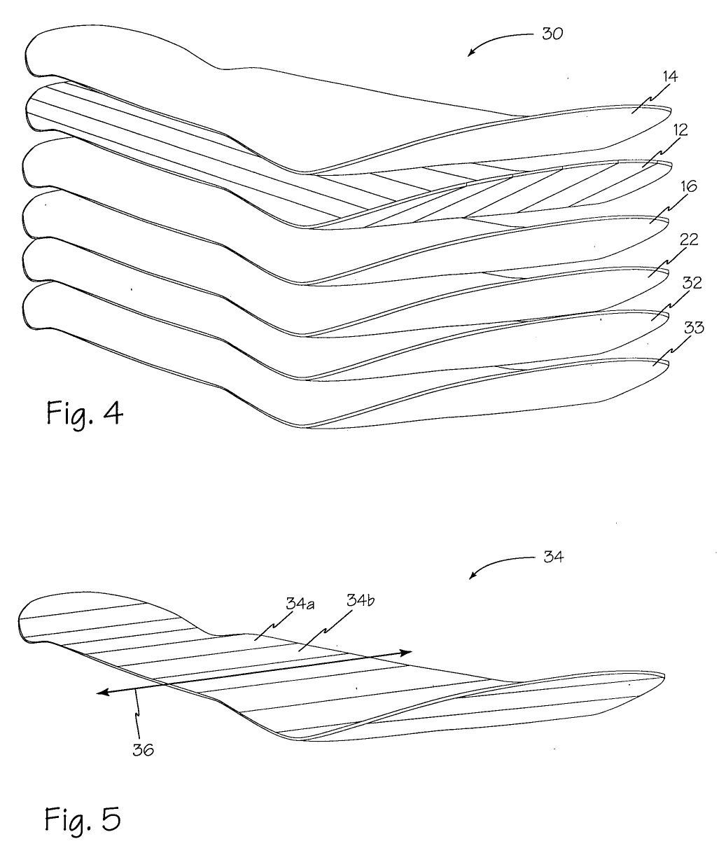

Referring now to FIG. 4, hybrid skateboard deck 30 may be composed of any suitable combination of woods and or other materials such as bamboo, metal or man-made composites. In deck 30 bamboo layer 12 is the second layer from the top and the top layer is maple layer 14. Maple layer 16 is below bamboo layer 12. Birch layer 22 is supported by hickory layer 32 and mesquite layer 33. In this example bamboo layer 12 has the strip axis oriented parallel to the long axis of the deck.

Referring now to FIG. 5, alternate bamboo layer 34 may be used in a hybrid deck such as deck 10 or deck 30 as an alternative to bamboo layer 12, or in addition to bamboo layer 12. Bamboo strips such as bamboo strips 34a and 34b are oriented with grain of the strips and thus the strip axis 36 perpendicular to long axis 26.

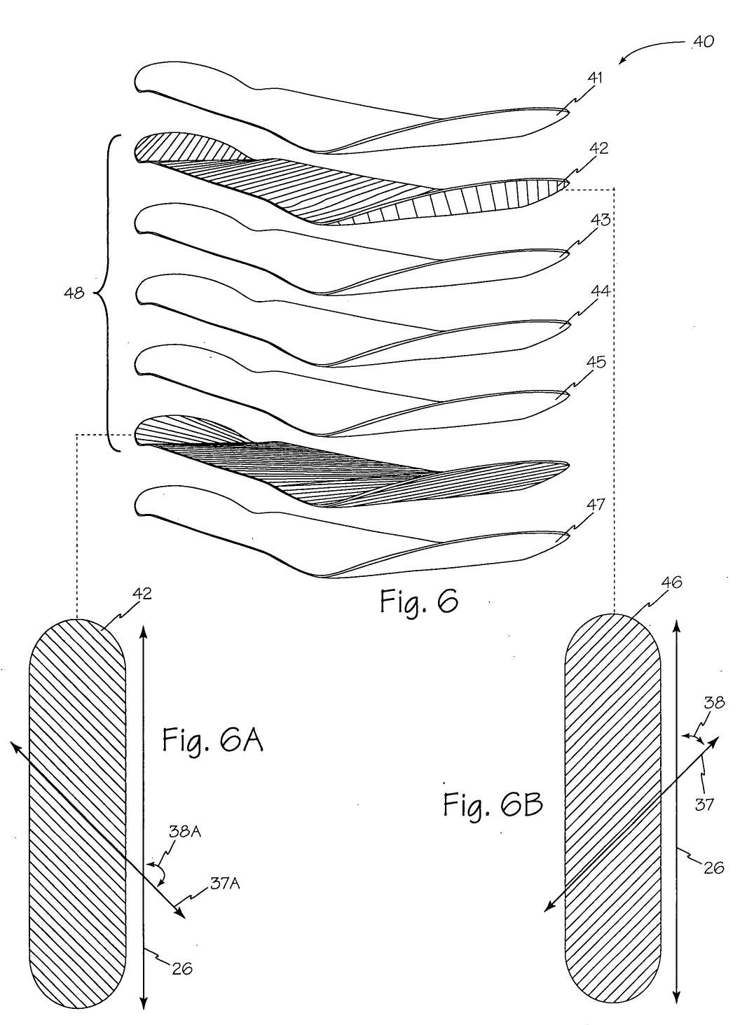

Referring now to FIG. 6, hybrid deck 40 includes top and bottom wood layers 41 and 47 surrounding hybrid core 48. Hybrid core may include one or more layers of material other than wood such as bamboo, metal or other man-made materials such as carbon composites or other material. In this example, hybrid core 48 includes bamboo layers 42 and 46 and wood layers 43, 44 and 45. As discussed above the variety of material layers may be arranged into a stack in any suitable order to achieve desired performance and strength.

As illustrated in FIGS. 6A and 6B any other suitable orientations of a strip axis may also be used such as orienting strip axis 37 to form acute angle 38 relative to long axis 26 as shown for bamboo layer 46 which may be described as a left slope layer. Alternatively, in bamboo layer 42 which may be described as a right slope layer, strip axis 37A may form an obtuse angle 38A relative to long axis 26.

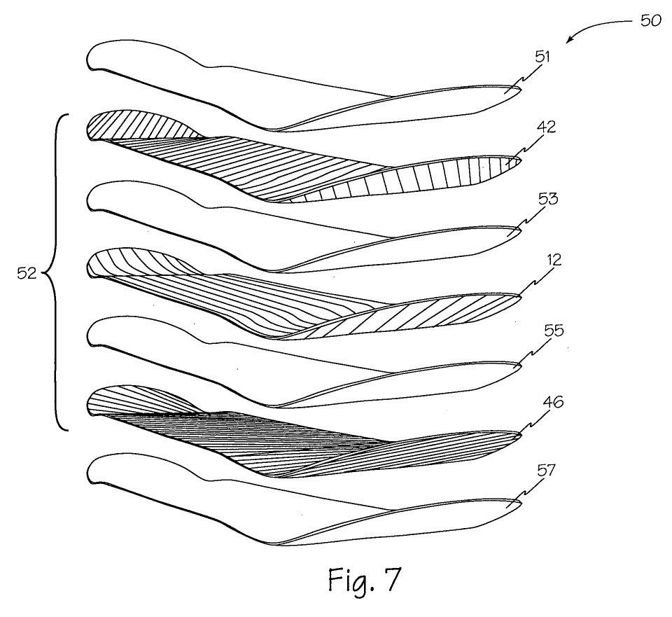

Referring now to FIG. 7, hybrid skateboard deck 50 includes outer layers of conventional wood surrounding hybrid core 52. Top layer 51 and bottom layer 57 may be formed of any suitable wood. Hybrid core 52 includes left slope bamboo layer 42, straight bamboo layer 12 and right slope bamboo layer 46 with other material layers 53 and 55.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

I claim:

1. A hybrid skateboard deck comprising:
an upper layer;
a lower layer; and
a core of one or more layers between the upper layer and the lower layer, with at least one layer of the core formed of bamboo.

2. The skateboard deck of claim 1 wherein the upper layer and the lower layer are formed of wood and the core further comprises:
three layers of material with at least one layer formed of bamboo.

3. The skateboard deck of claim 2 wherein the wood layers are formed of one or more woods selected from maple, birch, beech, cherry, elm, gum, hickory and or mesquite.

4. The skateboard deck of claim 3 wherein the core further comprises:
five layers of material with at least one layer formed of bamboo.

5. The skateboard deck of claim 3 wherein the core further comprises:
five layers of material with two layers formed of bamboo, each bamboo layer having a strip axis with each strip axis oriented perpendicular to the other strip axis.

6. A skateboard deck comprising:
a top layer formed of wood;
a second layer formed of a left slope bamboo layer supporting the top layer;
a third layer formed of wood supporting the second layer;
a fourth layer formed of a straight bamboo layer supporting the third layer;
a fifth layer formed of wood supporting the fourth layer;
a sixth layer formed of a right slope bamboo layer supporting the fifth layer;
a bottom layer formed of wood supporting the sixth layer; and
adhesive between each layer.

7. The skateboard deck of claim 6 wherein the wood layers are formed of one or more woods selected from maple, birch, beech, cherry, elm, gum, hickory and or mesquite.
